(19) United States
(12) Patent Application Publication
(10) Pub. No.: US 2006/0103355 A1
(43) Pub. Date: May 18, 2006

(54) Method and system for selectively charging a battery

(76) Inventors: Joseph Patino, Pembroke Pines, FL (US); David M. Demuro, Lawrenceville, GA (US)

Correspondence Address: MOTOROLA, INC;INTELLECTUAL PROPERTY SECTION, LAW DEPT, 8000 WEST SUNRISE BLVD, FT LAUDERDAL, FL, 33322, US

(21) Appl. No.: 10/990,132

(22) Filed: Nov. 16, 2004

(51) Int. Cl. H02J 7/00

(52) U.S. Cl. 320/138

(57) ABSTRACT

The invention concerns a method (300) and system (100) for selectively charging a battery (112). In one arrangement, the method can include the steps of coupling (311) the battery to a first power supply (114), coupling (311) the battery to a second power supply (116), determining (312) an available charging current parameter for the battery and selectively enabling (314) a charging circuit (120) for the first power supply and a charging circuit (122) for the second power supply based on the available charging current parameter of the battery. The selectively enabling process can be based on maximizing (316) an available charging current of the battery and minimizing (320) a power dissipation of the battery. As an example, the first power supply can be a hard-wired charger (114), and the second power supply can be a wireless charger (116).

### BACKGROUND OF THE INVENTION

1. Field of the Invention

This invention relates in general to methods for charging batteries and more particularly to methods for charging batteries through conventional and wireless chargers.

2. Description of the Related Art

Portable electronic devices have become ubiquitous in today's society. These devices are generally powered by one or more rechargeable batteries. For example, most cellular telephones can be coupled to a charger that can charge the telephone's battery after several hours, depending on how badly the battery is depleted. Consumers have many different types of chargers to choose from, including chargers that are physically coupled to the cellular telephone and wireless chargers. The chargers that are physically coupled to the cellular telephone may be referred to as standard or conventional chargers. Wireless chargers generally include a plate for receiving the device to be charged.

In view of these two different types of chargers, a user may couple the cellular telephone to a conventional charger and may also place the device on the plate of a wireless charger. Currently, cellular telephones are designed to grant the conventional charger with priority, meaning the conventional charger circuit is enabled and the wireless charging circuit is disabled. This prioritization process is done to prevent the battery from being overcharged, which can lead to a dangerous situation. While the current design improves safety, it nonetheless presents an inefficient way to charge batteries.

### SUMMARY OF THE INVENTION

The present invention concerns a method for selectively charging a battery. The method can include the steps of coupling the battery to a first power supply, coupling the battery to a second power supply, determining an available charging current parameter for the battery and selectively enabling a charging circuit for the first power supply and a charging circuit for the second power supply based on the available charging current parameter of the battery. In one arrangement, the selectively enabling step can further include selectively enabling the charging circuit for the first power supply and the charging circuit for the second power supply based on maximizing the available charging current parameter of the battery. In another arrangement, the selectively enabling step can further include enabling both the charging circuit for the first power supply and the charging circuit for the second power supply only if charging current generated by the first power supply and the second power supply is at or below the available charging current parameter.

Also, the selectively enabling step can further include selectively enabling the charging circuit for the first power supply and the charging circuit for the second power supply based on minimizing a power dissipation in the battery. In yet another arrangement, the selectively enabling step can further include minimizing the power dissipation in the battery by enabling at least one of the charging circuit for the first power supply and the charging circuit for the second power supply based on which of the first power supply and the second power supply will provide charging current at a lower charging voltage.

As an example, the first power supply can be a hard-wired charger, and the second power supply can be a wireless charger. The method can also include the steps of charging the battery with the hard-wired charger if the charging circuit for the first power supply is enabled and wirelessly charging the battery with the wireless charger if the charging circuit for the second power supply is enabled. As another example, the battery can be coupled to a portable electronic device. The portable electronic device can be a cellular telephone, a personal digital assistant, a two-way radio or a charger.

The present invention also concerns a system for selectively charging a battery. The system can include a first charging line that receives charging current from a first power supply, a second charging line that receives charging current from a second power supply and a processing unit. The processing unit can be programmed to determine an available charging current parameter for a battery and selectively enable at least one of the first charging line and the second charging line to provide charging current to the battery based on the available charging current parameter for the battery. The system also includes suitable software and circuitry to carry out the processes described above.

The present invention also concerns battery having a charging line that receives charging current from a first power supply and a second power supply and a processor coupled to the charging line. The processor can be programmed to operate in tandem with another processor in a portable electronic device to determine an available charging current parameter for the battery and selectively control charging current on the charging line from the first power supply and the second power supply based on the available charging current parameter for the battery. The processor can also be programmed to operate in tandem with the other processor to carry out the processes described above.

### BRIEF DESCRIPTION OF THE DRAWINGS

The features of the present invention, which are believed to be novel, are set forth with particularity in the appended claims. The invention, together with further objects and advantages thereof, may best be understood by reference to the following description, taken in conjunction with the accompanying drawings, in the several figures of which like reference numerals identify like elements, and in which:

FIG. 1 illustrates an example of a system for charging one or more batteries in accordance with an embodiment of the inventive arrangements;

FIG. 2 illustrates an exemplary schematic of the system of FIG. 1 in accordance with an embodiment of the inventive arrangements;

FIG. 3 illustrates a method for selectively charging a battery in accordance with an embodiment of the inventive arrangements; and

FIG. 4 illustrates a graph that demonstrates current and voltage levels in accordance with an embodiment of the inventive arrangements.

### DETAILED DESCRIPTION

While the specification concludes with claims defining the features of the invention that are regarded as novel, it is believed that the invention will be better understood from a consideration of the following description in conjunction with the drawing figures, in which like reference numerals are carried forward.

As required, detailed embodiments of the present invention are disclosed herein; however, it is to be understood that the disclosed embodiments are merely exemplary of the invention, which can be embodied in various forms. Therefore, specific structural and functional details disclosed herein are not to be interpreted as limiting, but merely as a basis for the claims and as a representative basis for teaching one skilled in the art to variously employ the present invention in virtually any appropriately detailed structure. Further, the terms and phrases used herein are not intended to be limiting but rather to provide an understandable description of the invention.

The terms a or an, as used herein, are defined as one or more than one. The term plurality, as used herein, is defined as two or more than two. The term another, as used herein, is defined as at least a second or more. The terms including and/or having, as used herein, are defined as comprising (i.e., open language). The term coupled, as used herein, is defined as connected, although not necessarily directly, and not necessarily mechanically. The terms program, software application, and the like as used herein, are defined as a sequence of instructions designed for execution on a computer system. A program, computer program, or software application may include a subroutine, a function, a procedure, an object method, an object implementation, an executable application, an applet, a servlet, a source code, an object code, a shared library/dynamic load library and/or other sequence of instructions designed for execution on a computer system.

This invention involves a method and system for selectively charging one or more batteries. In one arrangement, the method can include the steps of coupling a battery to a first power supply, coupling the battery to a second power supply and determining an available charging current parameter for the battery. The method can also include the step of selectively enabling a charging circuit for the first power supply and a charging circuit for the second power supply based on the available charging current parameter of the battery. The selectively enabling step can be based on maximizing the available charging current parameter of the battery. In addition, the selectively enabling step can be based on minimizing a power dissipation in the battery. As an example, the first power supply can be a hard-wired charger, and the second power supply can be a wireless charger.

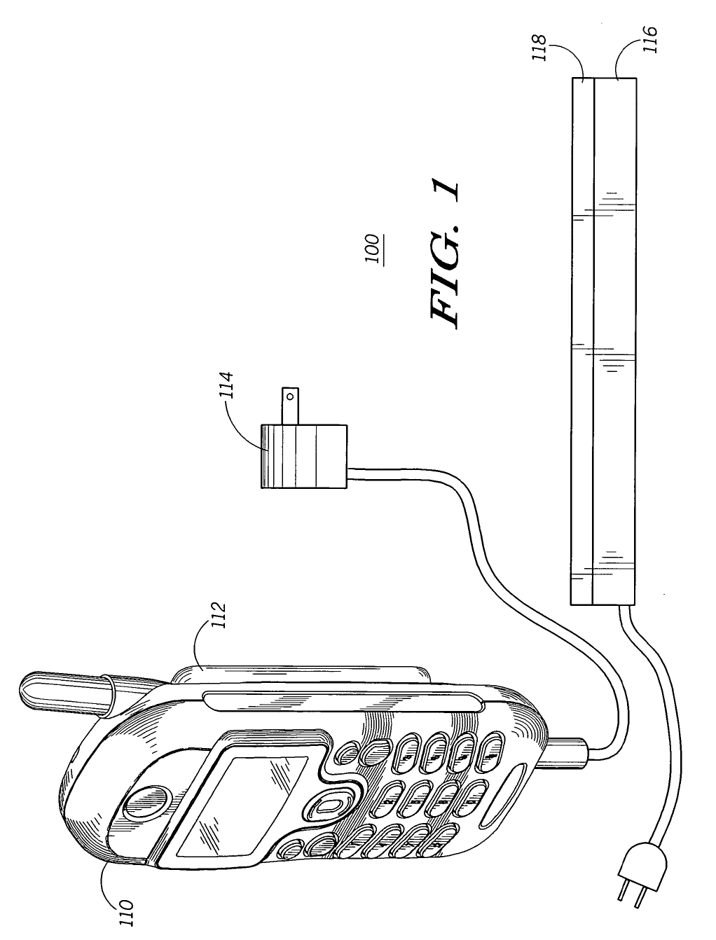

Referring to FIG. 1, a system 100 that can be used to charge selectively one or more batteries is shown. In one arrangement, the system 100 can include a portable electronic device 110 and a battery 112, which can be attachable to the portable electronic device 110. The battery 112 can provide power to the portable electronic device 110. As an example, the portable electronic device 110 can be a mobile communications unit, such as a cellular telephone, a personal digital assistant, a two-way radio, etc. As another example, the portable electronic device 110 can be a charger capable of charging the battery 112. As another example, the portable electronic device 110 can be a charger that is coupled to the battery 112. Of course, the portable electronic device 110 is in no way limited to these particular examples.

The system 100 can also include a first power supply 114 and a second power supply 116, both of which can provide charging current to the battery 112. As an example, the first power supply 114 can be a hard-wired charger in which the charger is physically linked to the portable electronic device 110. As another example, the second power supply 116 can be a wireless charger, which can include a plate 118 onto which the portable electronic device 110 can be placed. Through induction and as known in the art, the wireless charger can generate a charging current in the battery 112.

It is understood, however, that the invention is not limited to these examples, as the first power supply 114 and the second power supply 116 can be any device capable of providing a charging current to the battery 112. In addition, the charging current from the first power supply 114 or the second power supply 116 can be directly fed to the battery 112 without the presence of the portable electronic device 110, if such a configuration is desired.

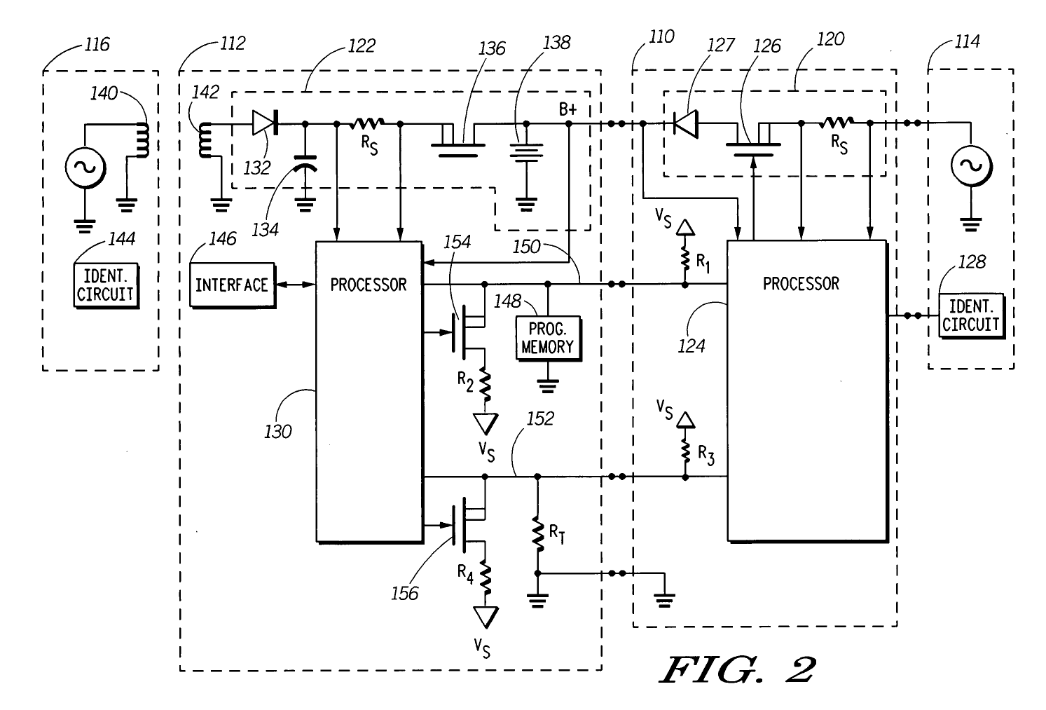

Referring to FIG. 2, a block diagram of an example of the portable electronic device 110, the battery 112, the first power supply 114 and the second power supply 116 is shown. In one arrangement, the portable electronic device 110 can have a first charging circuit or line 120, which can receive charging current from the first power supply 114. Further, the battery 112 can have a second charging circuit or line 122, which can receive charging current from the second power supply 116. The invention, however, can be arranged to enable the second power supply 116 to provide charging current to the portable electronic device 110 and for the first power supply 114 to present charging current to the battery 112.

In another arrangement, the portable electronic device 110 can include a processor 124, and the first charging line 120 can have a sense resistor Rₛ, a switch 126 and a diode 127. The processor 124 can include inputs on either side of the sense resistor R_{S}, which can permit the processor 124 to determine the amount of current flowing through the first charging line 120. In addition, the processor 124 can control this current flow by manipulating the operation of the switch 126.

In one embodiment, the first power supply 114 can include an identifier circuit 128, which the processor 124 can engage to determine the operating parameters of the first power supply 114. As an example, the operating parameters can be a charging voltage and a maximum charging current of the first power supply 114. In one embodiment, the identifier circuit 128 can be a resistor identification scheme, although those of skill in the art will appreciate that other configurations can be implemented to allow the processor 124 to determine operating parameters of the first power supply 114.

The battery 112 can also include a processor 130, and the second charging line 122 can include a diode (or rectifier) 132, a charging capacitor 134, a sense resistor R_{S}, a switch 136 and one or more cells 138. Like the processor 124, the processor 130 of the battery 112 can include inputs on either side of the sense resistor R_{S} to determine the amount of current flowing through the second charging line 122. The processor 130 can also control this current through the switch 136. In one arrangement, the processor 124 and the processor 130 may be referred to as a processing unit, either jointly or individually.

As explained earlier, the second power supply 116 may be a wireless charger. In this case, the second power supply 116 can include a set of primary windings 140, and the battery 112 can include a set of corresponding secondary windings 142. As is known in the art, the primary windings 140 can generate a charging current in the secondary windings 142. The second power supply 116 can also include an identifier circuit 144, which can be used to help the processor 130 identify the operating parameters of the second power supply 116. One example of an operating parameter can be the charging voltage and the maximum charging current of the second power supply 116. In one particular embodiment, the identifier circuit 144 can include components for wirelessly transmitting information concerning the operating parameters of the second power supply 116. The battery 112 can also include an interface 146 for receiving this information and for passing it to the processor 130. Of course, other suitable configurations can be employed to permit the processor 130 to acquire information about the second power supply 116.

The battery 112 may also contain a programmable memory 148, which can be programmed with the operating parameters of the battery 112. These operating parameters can include, for example, a maximum charging voltage, a maximum temperature, a maximum charging current and a predetermined charging voltage threshold for the battery 112. Specifically, the maximum charging current can identify the maximum amount of charging current that the battery 112 can receive as it is being charged. In addition, the predetermined charging voltage threshold for the battery 112 can identify the voltage at which the amount of charging current may be gradually decreased during the charging process, a step that is known in the art. The maximum charging voltage of the battery 112 may or may not equal the predetermined charging voltage threshold for the battery 112.

In another embodiment, the programmable memory 148 can be an erasable programmable read only memory (EPROM) or an electrically erasable programmable read only memory (EEPROM), although other forms of programmable memory are within contemplation of the inventive arrangements. The programmable memory 148 can be coupled to an input/output (I/O) line 150, which can be coupled to both the processor 124 of the portable electronic device 110 and the processor 130 of the battery 112. A voltage supply V_{S} can also be coupled to the I/O line 150 through a pull-up resistor R₁. Through the I/O line 150, the processor 124 and the processor 130 can determine the operating parameters of the battery 112.

In another arrangement, another pull-up resistor R₂ and another switch 154 can be coupled to the voltage supply V_{S} and the I/O line 150. This configuration may be useful if the battery 112 is to be charged without the assistance of the portable electronic device 110. That is, the processor 130 of the battery 112 can activate the switch 154, which can permit the pull-up resistor R₂ to be coupled to the I/O line 152 in the absence of the portable electronic device 110.

The battery 112 can also have a thermistor line 152, which can also be coupled to both the processor 124 and the processor 130. The voltage supply V_{S} can also be coupled to the thermistor line 152 through another pull-up resistor R₃, and a thermistor R_{T} can be coupled to the thermistor line 152. As those of skill in the art will appreciate, the pull-up resistor R₂ and the thermistor R_{T} can provide a voltage divider network to permit the processor 124 or the processor 130 to determine the temperature of the battery 112.

Similar to the I/O line 150, another pull-up resistor R₄ and another switch 156 can be coupled to the voltage supply V_{S} and the thermistor line 152. The processor 130 can control the operation of the switch 156. This configuration can permit the temperature of the battery 112 to be monitored if the battery 112 is being charged without the assistance of the portable electronic device 110.

Although FIG. 2 illustrates one example of a system for selectively charging a battery, it is important to note that the invention is not so limited. For example, the first charging line 120 is not required to be in the portable electronic device 110, and the second charging line 122 does not have to be in the battery 112. Moreover, the portable electronic device 110 can be a charger, and the first power supply 114, in this arrangement, can be part of the portable electronic device 110. In addition, the battery 112 is not required to have a processor, as some other component that can supply power to the battery 112 can contain the second charging line 122 and the processor 130.

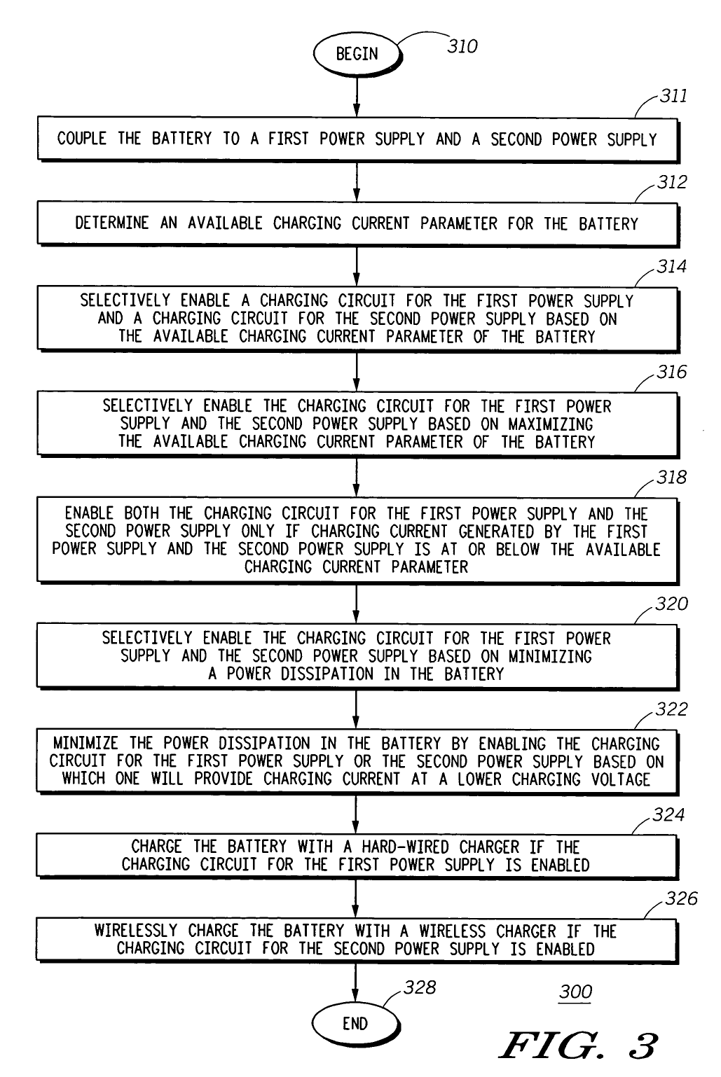

Referring to FIG. 3, a method 300 for selectively charging a battery is shown. To describe the method 300, reference may be made to FIGS. 1 and 2, although the method 300 can be practiced using any other suitable devices or systems. That is, a system for exchanging data in accordance with the inventive arrangements is not limited to that pictured in FIG. 2. Moreover, the method 300 is not limited to the particular steps that are shown in FIG. 3 or to the order in which they are depicted. The inventive method 300 may also include a fewer or greater number of steps as compared to what is shown in FIG. 3.

At step 310, the method 300 can begin. At step 311, a battery can be coupled to a first power supply, and the battery can be coupled to a second power supply. At step 312, an available charging current parameter for the battery can be determined. For example, referring to FIGS. 1 and 2, the battery 112 can be coupled to the first power supply 114, such as through the portable electronic device 110. The battery 112 can also be coupled to the second power supply 116. When the first power supply 114 is coupled to the battery 112 (through the portable electronic device 110), the processor 124 can determine the operating parameters of the first power supply 114, such as the charging voltage and maximum charging current.

An available charging current parameter can be determined for the battery 112. In particular, the processor 124 may signal the programmable memory 148, which can then provide to the processor 124 information concerning the operating parameters of the battery 112. As mentioned earlier, these operating parameters can include, for example, the maximum charging voltage, the maximum temperature, the maximum charging current and the predetermined charging voltage threshold of the battery 112. The processor 130 of the battery 112 may also access this information from the programmable memory 148.

Once the maximum charging current is determined, the processor 124 or the processor 130 can determine the available charging current parameter of the battery 112. The available charging current parameter may be a variable value. In particular, many batteries, as explained earlier and as is known in the art, reduce the flow of charging current to a battery once the battery reaches a predetermined charging voltage threshold. Thus, the available charging current parameter of the battery 112 may be adjusted based on the charging voltage of the battery 112.

For example, if the charging voltage on the battery 112 is below the predetermined charging voltage threshold mentioned above, the available charging current parameter may be equal to the maximum charging current. As a more specific example, the battery 112 may have a maximum charging current of 900 milliamps (mA). If the charging voltage currently on the battery 112 is below the predetermined charging voltage threshold, the processor 124 or the processor 130 can determine that the available charging current parameter can be 900 mA.

If, however, the charging voltage on the battery 112 at least matches the predetermined charging voltage threshold, the processor 124 or the processor 130 can determine that the available charging current parameter should be less than the maximum charging current. The processor 124 or the processor 130 can be programmed with tables that provide various charging voltages and their corresponding charging currents, or these values can be stored in the programmable memory 148. Thus, the processor 124 or the processor 130 can access this information and select a charging current based on the present charge of the battery 112. This selected charging current can be the available charging current parameter. The process of correlating charging currents to present charging voltages on a battery is well known, and any suitable algorithm can be used here. Thus, the term available charging current parameter can represent that amount of charging current with respect to time that the battery 112 is designed to receive over the course of a charging cycle.

As an alternative, the available charging current parameter can be calculated by one of the processors 124, 130, which can eliminate the need for storing the charging voltages and their corresponding charging currents. For example, the processor 124 or the processor 130 can determine the available charging current parameter by subtracting the maximum charging voltage of the battery 112 by the actual charge on the battery 122 and then dividing the difference by the total impedance of the battery 112 (the total resistance of the battery 112 can be stored in, for example, a table of the processors 124, 130 or the programmable memory 1480. Of course, those of skill in the art will appreciate that there may be other suitable methods for determining the available charging current parameter, all of which may be applicable here.

Referring back to the method 300, at step 314, a charging circuit for the first power supply and a charging circuit for the second power supply can be selectively enabled. This selective enablement can be based on the available charging current parameter. At step 316, in one embodiment, the charging circuit for the first power supply and the second power supply can be selectively enabled based on maximizing the available charging current parameter of the battery. In another arrangement and as shown at step 318, both the charging circuit for the first power supply and the second power supply may be enabled only if charging current generated by the first power supply and the second power supply is at or below the available charging current parameter.

For example, referring once again to FIGS. 1 and 2, the first charging line 120 for the first power supply 114 and the second charging line 122 for the second power supply 116 can be selectively enabled. In one particular embodiment, the processor 124 can signal the processor 130 over the I/0 line 150 with information concerning the operating parameters of the first power supply 114, such as its maximum charging current. Similarly, the processor 130 can provide the processor 124 over the I/O line 150 with information concerning the operation of the second power supply 116, including the maximum charging current of the second power supply 116. One or both of the processors 124, 130 can then determine which of the first charging line 120 or second charging line 122 should be enabled.

For example, the battery 112 may have a maximum charging current of 900 milliamps (mA), and the charging voltage currently on the battery 112 may be below the predetermined charging voltage threshold. As such, the maximum charging current can be the available charging current parameter of the battery 112. Additionally, the maximum charging capacity of the first power supply 114 may be 450 mA, and the maximum charging capacity of the second power supply may be 450 mA. In view of these circumstances, the processor 124 can enable the first charging line 120 by activating the switch 126. Likewise, the processor 130 can enable the second charging line 122 by turning on the switch 136. As a result, the total charging current that can be supplied to the battery 112 can be 900 mA, which equals the available charging current parameter of 900 mA. In this example, the charging current to the battery 112 can be maximized without risking overcharging the battery 112.

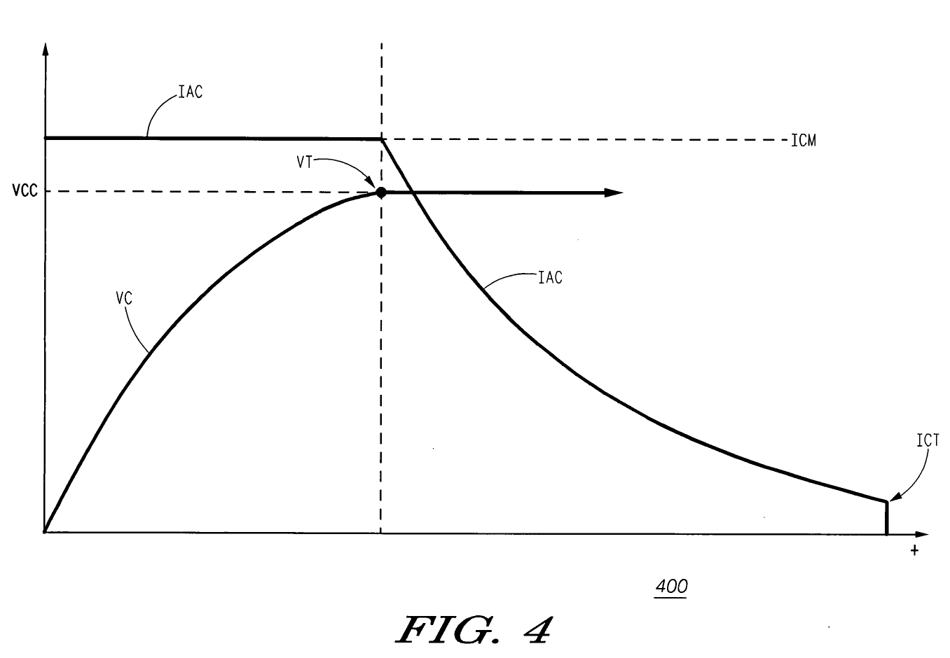

Referring to FIGS. 2 and 4, a graph 400 is shown that will help explain the previous example plus several other charging scenarios. Here, the graph has a threshold V_{CC} that represents the maximum charging voltage of the battery 112 and a line V_{C} that signifies the charging voltage of the battery 112 over time. The graph 400 also shows an available charging current parameter I_{AC}, which represents the level of charging current that the battery 112 is designed to receive over the course of the charging process up to a cutoff point I_{CT}. In addition, the predetermined charging voltage threshold is represented by the point V_{T}, and a current line I_{CM} symbolizes the maximum charging current of the battery 112.

As can be seen, the maximum charging current I_{CM} can roughly equal the available charging current parameter I_{AC} prior to the predetermined charging voltage threshold V_{T}. Of course, the invention is not so limited, as the available charging current parameter I_{AC} can be lower or even greater than the maximum charging current I_{CM}. Also, the predetermined charging voltage threshold V_{T} can be equal to the maximum charging voltage V_{CC}, although the predetermined charging voltage threshold V_{T} can have other suitable values.

In one embodiment, before the charging voltage V_{C} reaches the predetermined charging voltage threshold V_{T}, attempts can be made to get the charging current supplied to the battery 112 as close to the available charging current parameter I_{AC} of the battery 112 while remaining below the available charging current parameter I_{AC}. For instance, consider the following example: the available charging current parameter I_{AC} is 900 mA, and the first power supply 114 can provide 500 mA and the second power supply 116 can provide 500 mA. The processor 124 or the processor 130 can manipulate one of the switches 126, 136 respectively to permit one of the first power supply 114 or the second power supply 116 to provide 500 mA and the other to supply 400 mA. Thus, the current output of either the first power supply 114 or the second power supply 116 (or both) can be varied to keep the charging current as close to the available charging current parameter I_{AC} without exceeding it.

As another example, consider the following scenario: the available charging current parameter I_{AC} may be 400 mA, and the first power supply 114 can have a maximum output of 400 mA, and the second power supply 116 can also have a maximum output of 400 mA. One of the processors 124 or 130 can enable its respective charging line 120 or 122, and the other charging line 120 or 122 can be disabled. In this example and the ones described above, both the first charging line 120 for the first power supply 114 and the second charging line 122 for the second power supply 116 can be enabled only if the charging current generated by the first power supply 114 and the second power supply 116 is below the available charging current parameter I_{AC}. This principle may apply when the charging voltage V_{C} is below or, as will be later explained, above the predetermined charging voltage threshold V_{T}.

Referring back to the method 300 of FIG. 3, at step 320, the charging circuit for the first power supply and the charging circuit for the second power supply can be selectively enabled based on minimizing a power dissipation in the battery. At step 322, the power dissipation in the battery can be minimized by enabling the charging circuit for the first power supply or the second power supply based on which one will provide charging current at a lower charging voltage.

Referring back to FIGS. 2 and 4, the processor 124 or the processor 130 can selectively enable the first charging circuit 114 or the second charging circuit 116, respectively, based on minimizing power dissipation in the battery 112. The phrase based on minimizing power dissipation in the battery can mean enabling charging circuits where the selection will cause a lower amount of dissipated power in a battery or other component in view of the other available selections. As an example, the minimization of power dissipation can occur in a charging circuit in the battery 112, a charging circuit of the portable electronic device 110 or any other component or circuit or combination of components or circuits and all those scenarios are contemplated by the phrase minimizing power dissipation in the battery. The selectively enabling process can occur when the charging voltage V_{C} on the battery 112 at least matches the predetermined charging voltage threshold V_{T}.

As noted earlier, when a charging voltage on a battery reaches a predetermined threshold, the charging current may be gradually decreased. Here, the available charging current parameter I_{AC} can follow a path that is set by the information relating to the charging voltages and their corresponding charging currents that are programmed in the processor 124 and/or the processor 130 and/or the programmable memory 148.

As the need for charging current drops, the processor 124 and/or the processor 130 can make adjustments by controlling the flow of current through the first charging line 120 and the second charging line 122. For example, consider the following set of circumstances: the charging voltage V_{C} on the battery 112 matches the predetermined charging voltage threshold V_{T}; the available charging current parameter I_{AC} has dropped to roughly 400 mA; the first power supply 114 provides a maximum of 400 mA at six volts; and the second power supply 116 provides a maximum of 400 mA at five volts. To minimize power dissipation in the battery 112, the processor 130 can enable (or keep enabled) the second charging line 122 through manipulation of the switch 136. Moreover, the processor 124 can disable (or keep disabled) the first charging line 120 by deactivating the switch 126. Thus, the needed 400 mA can be provided at a lower voltage through the second charging line 122.

The processor 124 and/or the processor 130 can continuously make adjustments in their respective charging lines 120, 122 as the available charging current parameter I_{AC} drops. Continuing with the above example, if the available charging current parameter I_{AC} drops to 375 mA, the processor 130 can reduce the flow of current from the second power supply 116 through the second charging line 122 by controlling the switch 136. As an alternative, if the first power supply 114 can supply 375 mA at a lower voltage than the second power supply 116, then the processor 130 can turn off the second charging line 122. In addition, the processor 124 can enable the first charging line 120 through operation of the switch 126 to permit the first power supply 114 to provide the charging current.

If both the first power 114 and the second power supply 116 are to be used simultaneously in this stage, the processor 124 and the processor 130 can maintain the charging currents from each one with a goal of minimizing power dissipation. For example, consider another scenario: the available charging current parameter I_{AC} is 750 mA; the charging voltage V_{C} on the battery 112 matches the predetermined charging voltage threshold V_{T}; the first power supply 114 produces 400 mA at 5 volts and 350 mA at 4.8 volts; and the second power supply 116 produces 400 mA at 5 volts and 350 mA at 4.7 volts. Here, the processor 124 can enable the first charging line 120 to permit the first power supply 114 to provide 400 mA, while the processor 130 can enable the second charging line 122 to allow the second power supply 116 to supply the 350 mA at the lower voltage. As a result, the more efficient second power supply 116 (at least at this charging current) can supply the lower 350 mA current.

The processor 124 and the processor 130 can also continuously update any charging configurations to ensure minimal power dissipation as the available charging current parameter I_{AC} continues to drop. This process of minimizing power dissipation can also apply to the charging stage where the charging voltage V_{C} on the battery 112 is less than the predetermined charging voltage threshold V_{T}. It also important to note that the invention is in no way limited to the above examples, as any power supplies can be selected for providing charging current to the battery 112 with a focus on reducing energy waste in the battery 112.

Referring once again to the method 300 of FIG. 3, at step 324, the battery can be charged with a hard-wired charger if the charging circuit for the first power supply is enabled. At step 326, the battery can be wirelessly charged with the wireless charger if the charging circuit for the second power supply is enabled. The method 300 can end at step 328.

For example, referring to FIG. 2, the first power supply 114 can be a hard-wired charger, which can supply charging current to the battery 112 when the processor 124 enables the first charging line 120. A hard-wired charger can be any charger where a physical link exists between the charger and the battery 112 or the portable electronic device 110 that the battery 112 powers. Conversely, the second power supply 116 can be a wireless charger, which can charge the battery 112 when the second charging line 122 is enabled. A wireless charger can be any charger that induces a charging current in the battery 112 without a physical link between the charger and the battery 112 or the portable electronic device 110. Of course, both the first power supply 114 and the second power supply 116 can both be hard-wired chargers or both can be wireless chargers. Additionally, the system 100 can include more than two power supplies for providing power to the battery 112.

The present invention can be realized in hardware, software or a combination of hardware and software. Any kind of computer system or other apparatus adapted for carrying out the methods described herein are suitable. A typical combination of hardware and software can be a mobile communication device with a computer program that, when being loaded and executed, can control the mobile communication device such that it carries out the methods described herein. The present invention can also be embedded in a computer program product, which comprises all the features enabling the implementation of the methods described herein and which when loaded in a computer system, is able to carry out these methods.

While the preferred embodiments of the invention have been illustrated and described, it will be clear that the invention is not so limited. Numerous modifications, changes, variations, substitutions and equivalents will occur to those skilled in the art without departing from the spirit and scope of the present invention as defined by the appended claims.

What is claimed is:

1. A method for selectively charging a battery, comprising the steps of:
coupling the battery to a first power supply;
coupling the battery to a second power supply;
determining an available charging current parameter for the battery; and
selectively enabling a charging circuit for the first power supply and a charging circuit for the second power supply based on the available charging current parameter of the battery.

2. The method according to claim 1, wherein the selectively enabling step further comprises selectively enabling the charging circuit for the first power supply and the charging circuit for the second power supply based on maximizing the available charging current parameter of the battery.

3. The method according to claim 2, wherein the selectively enabling step further comprises enabling both the charging circuit for the first power supply and the charging circuit for the second power supply only if charging current generated by the first power supply and the second power supply is at least one of at and below the available charging current parameter.

4. The method according to claim 1, wherein the selectively enabling step further comprises selectively enabling the charging circuit for the first power supply and the charging circuit for the second power supply based on minimizing a power dissipation in the battery.

5. The method according to claim 4, wherein the selectively enabling step further comprises minimizing the power dissipation in the battery by enabling at least one of the charging circuit for the first power supply and the charging circuit for the second power supply based on which of the first power supply and the second power supply will provide charging current at a lower charging voltage.

6. The method according to claim 1, wherein the first power supply is a hard-wired charger and the second power supply is a wireless charger and the method further comprises the steps of:
charging the battery with the hard-wired charger if the charging circuit for the first power supply is enabled; and
wirelessly charging the battery with the wireless charger if the charging circuit for the second power supply is enabled.

7. The method according to claim 1, wherein the battery is coupled to a portable electronic device.

8. The method according to claim 7, wherein the portable electronic device is at least one of a cellular telephone, a personal digital assistant, a two-way radio and a charger.

9. A system for selectively charging a battery, comprising:
a first charging line that receives charging current from a first power supply;
a second charging line that receives charging current from a second power supply; and
a processing unit, wherein the processing unit is programmed to:
determine an available charging current parameter for a battery; and
selectively enable at least one of the first charging line and the second charging line to provide charging current to the battery based on the available charging current parameter for the battery.

10. The system according to claim 9, wherein the processing unit is programmed to selectively enable the first and second charging lines based on maximizing the available charging current parameter.

11. The system according to claim 10, wherein the processing unit is programmed to enable both the first charging line and the second charging line only if charging current generated by the first power supply and the second power supply is at least one of at and below the available charging current parameter.

12. The system according to claim 9, wherein the processing unit is programmed to selectively enable the first charging line for the first power supply and the second charging line for the second power supply based on minimizing a power dissipation in the battery.

13. The system according to claim 12, wherein the processing unit is programmed to minimize the power dissipation in the battery by enabling at least one of the first charging line for the first power supply and the second charging line for the second power supply based on which of the first power supply and the second power supply will provide charging current at a lower charging voltage.

14. The system according to claim 9, further comprising a portable electronic device, wherein the first charging line is in the portable electronic device and the second charging line is in the battery.

15. The system according to claim 9, wherein the first power supply is a hard-wired charger and the second power supply is a wireless charger, wherein the hard-wired charger charges the battery if the first charging line is enabled and the wireless charger charges the battery if the second charging line is enabled.

16. The system according to claim 9, wherein the portable electronic device is at least one of a cellular telephone, a personal digital assistant, a two-way radio and a charger.

17. A battery, comprising:
a charging line that receives charging current from a first power supply and a second power supply; and
a processor coupled to the charging line, wherein the processor is programmed to operate in tandem with another processor in a portable electronic device to:
determine an available charging current parameter for the battery; and
selectively control charging current on the charging line from the first power supply and the second power supply based on the available charging current parameter for the battery.

18. The battery according to claim 17, wherein the battery processor is further programmed to operate in tandem with the processor in the portable electronic device by selectively controlling the charging current on the charging line based on maximizing the available charging current parameter.

19. The battery according to claim 17, wherein the battery processor is further programmed to operate in tandem with the processor in the portable electronic device by selectively controlling the charging current on the charging line based on minimizing a power dissipation in the battery.

20. The battery according to claim 17, wherein the first power supply is a hard-wired charger and the second power supply is a wireless charger.

21. The battery according to claim 17, wherein the portable electronic device is at least one of a cellular telephone, a personal digital assistant, a two-way radio and a charger.
